(19) United States
(12) Patent Application Publication
(10) Pub. No.: US 2007/0036337 A1
(43) Pub. Date: Feb. 15, 2007

(54) Methods, systems, and computer program products for provisioning a subscriber line (SL) using a circuit identification

(76) Inventor: Tingting Lu, Alpharetta, GA (US)

Correspondence Address: MYERS BIGEL SIBLEY & SAJOVEC, P.A., P.O. BOX 37428, RALEIGH, NC, 27627, US

(21) Appl. No.: 11/297,579

(22) Filed: Dec. 8, 2005

Related U.S. Application Data
(60) Provisional application No. 60/700,163, filed on Jul. 18, 2005.

(51) Int. Cl. H04M 1/00

(52) U.S. Cl. 379/399.01; 370/352

(57) ABSTRACT

A subscriber line (SL) is provisioned by disassociating the SL with a telephone number and associating the SL with a circuit identifier in a communications network.

### RELATED APPLICATION

This application claims the benefit of and priority to U.S. Provisional Patent Application No. 60/700,163, filed Jul. 18, 2005, the disclosure of which is hereby incorporated herein by reference as if set forth in its entirety.

### FIELD OF THE INVENTION

The present invention relates to communication networks and methods of operating the same, and, more particularly, to methods, system, and computer program products for provisioning subscriber lines (SLs) in communication networks.

### BACKGROUND OF THE INVENTION

Internet telephony, also referred to herein as Voice-Over Internet Protocol (VoIP), Voice-Over Network (VoN), and/or Internet Protocol Telephony (IP Telephony), is becoming increasingly popular due, in part, to marked improvements in reliability and sound quality of the service. The improved performance of Internet telephony communications may be due to upgrades made to the Internet backbone through improved switching fabrics, such as Asynchronous Transfer Mode (ATM) fabrics, and to implementation of new communications standards, such as standards for transport protocols, directory services, and/or audio codec format.

Currently, to provide Internet telephony communications to a customer, a customer obtains equipment, such as Integrated Access Devices (IADs), Analog Terminal Adaptors (ATAs), telephone adapters (TAs), and the like, to be installed at the customer's premises, for example, a customer's home. The equipment is used to support a voice path within the premises and through a broadband connection, for example, a digital subscriber line (DSL) connection, back to an Internet Service Provider (ISP). Once the necessary equipment is installed, customers/subscribers can connect their existing analog phones, for example, Plain Old Telephone Service (POTS) phones, to the ATA(s). The ATA(s) provide such functionality as dial tone, battery, and power ringing as part of providing POTS functionality through the VoN service. Normally, a Central Office (CO) switch provides dial tone, battery, and power ringing for analog phones.

Historically, Incumbent Local Exchange Carriers (ILECs) have viewed DSL service as an attribute of POTS service. For example, as illustrated in FIG. 1, a communication network 100 includes customer premises devices, such as a computer and analog phone, that are connected to a DSL via a DSL modem 110 and DSL filter 120, respectively. The DSL terminates at a Digital Subscriber Line Access Multiplexer (DSLAM) 130 where multiple DSL lines are typically multiplexed and the voice and data components are aggregated for transmission over the network. As shown in the FIG. 1, the data components are aggregated for transmission over an ATM network 140, an Internet Protocol/Multiprotocol Label Switching (IP/MPLS) network 150, and the Internet 160. The voice components are aggregated for transmission over the Public Switched Telephone Network (PSTN) 170. ILECs have managed DSL lines based on the POTS telephone number that is associated with the DSL line. Customers that subscribe to VoN service, however, may choose to eliminate their POTS service, which may result in managing DSL connections based on telephone numbers inconvenient and/or cumbersome. Moreover, pseudo telephone numbers may be created for the purpose of managing DSL connections, which may be wasteful as these telephone numbers are not used to provide actual communication service, but are used solely as an identifier for the DSL connections.

### SUMMARY OF THE INVENTION

According to some embodiments of the present invention, a subscriber line (SL) is provisioned by disassociating the SL with a telephone number and associating the SL with a circuit identifier in a communications network.

In other embodiments, the SL may be a digital subscriber line (DSL) or an analog subscriber line (ASL).

In other embodiments of the present invention, the telephone number is ported from an Incumbent Local Exchange Carrier (ILEC) to a Competitive Local Exchange Carrier (CLEC) that provides Internet Protocol Voice over Network (IP-VoN) service. Plain Old Telephone Service (POTS) is canceled on the DSL.

In still other embodiments of the present invention, an association of the telephone number with IP-VoN service is canceled. The telephone number is associated with Central Office Voice over Network (CO-VoN) service. The DSL is provisioned to use a shadow line telephone number with hotline service to route originating calls to a softswitch complex. The DSL is provisioned with calling name to identify a party associated with an incoming call.

In still other embodiments of the present invention, Plain Old Telephone Service (POTS) is canceled on the DSL.

In still other embodiments of the present invention, the telephone number is a first telephone number, and Internet Protocol Voice over Network (IP-VoN) service is provisioned using a second telephone number. Plain Old Telephone Service (POTS) is maintained on the DSL using the first telephone number.

In still other embodiments of the present invention, the telephone number is ported from an Incumbent Local Exchange Carrier (ILEC) to a Competitive Local Exchange Carrier (CLEC) that provides Central Office Voice over Network (CO-VoN) service while leaving the DSL intact. Plain Old Telephone Service (POTS) is canceled on the DSL. The DSL is provisioned to use a shadow line telephone number with hotline service to route originating calls to a softswitch complex. The DSL is also provisioned with calling name to identify a party associated with an incoming call.

In still other embodiments of the present invention, an association of the telephone number with CO-VoN service is canceled. The telephone number is associated with Internet Protocol Voice over Network (IP-VoN) service. The shadow line number, hotline service, and calling name are canceled.

In still other embodiments of the present invention, the CLEC also provides Internet Protocol Voice over Network (IP-VoN) service.

In still other embodiments of the present invention, the telephone number is ported from a Competitive Local Exchange Carrier (CLEC) that provides Internet Protocol Voice over Network (IP-VoN) service to an Incumbent Local Exchange Carrier (ILEC). Plain Old Telephone Service (POTS) is provisioned on the DSL using the telephone number.

In still other embodiments of the present invention, the telephone number is ported from a Competitive Local Exchange Carrier (CLEC) that provides Central Office Voice over Network (CO-VoN) service to an Incumbent Local Exchange Carrier (ILEC). A shadow line number and a hotline service used to route originating calls on the DSL to a softswitch complex are canceled. Plain Old Telephone Service (POTS) is provisioned on the DSL using the telephone number.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a conventional communication network that provides digital subscriber line (DSL) service;

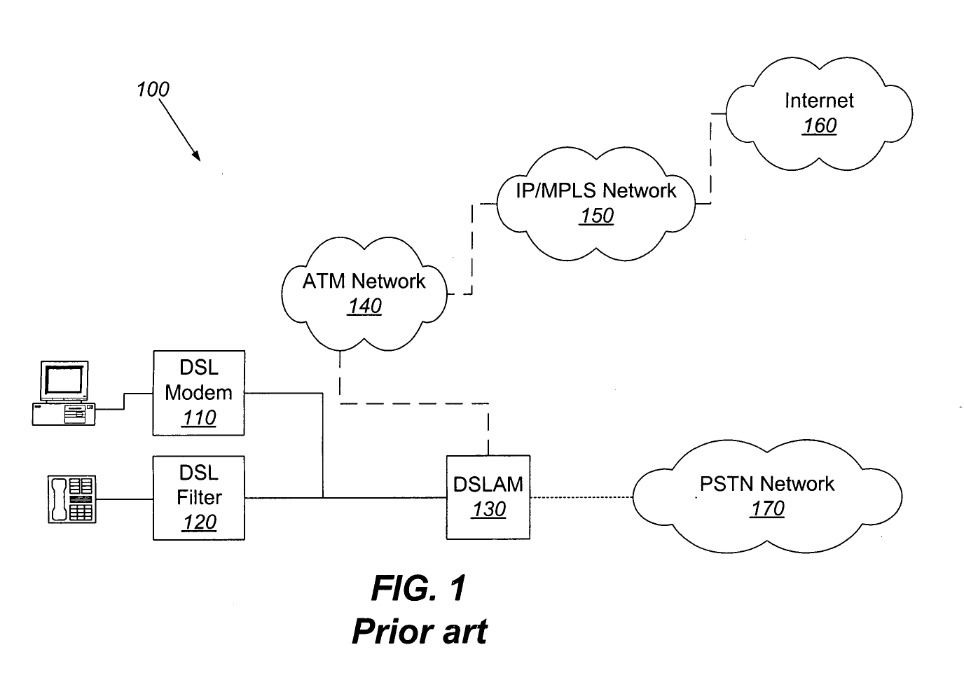

FIG. 2 is a block diagram that illustrates provisioning a DSL line based on a circuit identification in accordance with some embodiments of the present invention;

FIG. 3 illustrates a communication network that illustrates provisioning a DSL line based on a circuit identification in accordance with some embodiments of the present invention; and

FIG. 4 is a flowchart that illustrates operations for provisioning a DSL line based on a circuit identification in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of illustration, some embodiments of the present invention are described herein with respect to provisioning a digital subscriber line (DSL) using a circuit identification. It will be understood, however, that other types of subscriber lines (SLs), such as analog subscriber lines or Plain Old Telephone Service (POTS) lines may also be provisioned using a circuit identification.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

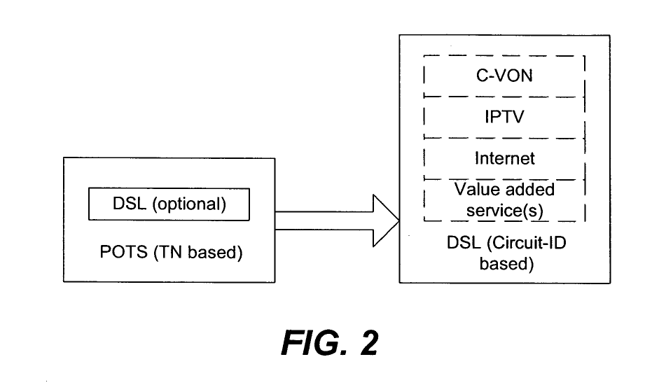

Referring now to FIG. 2, some embodiments of the present invention stem from a realization that a Digital Subscriber Line (DSL) may be converted from an attribute of Plain Old Telephone Service (POTS) to a circuit based identification. Thus, a DSL may be identified with a circuit identifier and various services, such as Consumer Voice over Network (C-VoN), Internet Protocol Television (IPTV), Internet Service, POTS, and other value added services may be associated with the circuit. Advantageously, this may allow Incumbent Local Exchange Carriers (ILECs), Competitive Local Exchange Carriers (CLECs) and/or other service providers to view telephone numbers as a logical and portable object that is not necessarily tied to a specific physical facility. For example, an ILEC may now provide true standalone DSL service, i.e., a DSL broadband connection without POTS service. In the past, even though a customer was not provided with POTS service, a pseudo telephone number was assigned to the DSL to manage the DSL service. By using a circuit identification to manage the DSL, a pseudo telephone number is no longer necessary. Moreover, management of the DSL is simplified as customers subscribe to particular C-VoN services, such as Internet Protocol VoN (IP-VoN) and/or Central Office VoN (CO-VoN) as these services may require porting a telephone number from an ILEC to a CLEC, which may require that the DSL be taken out of service if the DSL is managed based on telephone number. If the DSL is managed based on a circuit identification, however, than there may be no need to disrupt DSL service or the length of time that service is disrupted may be reduced.

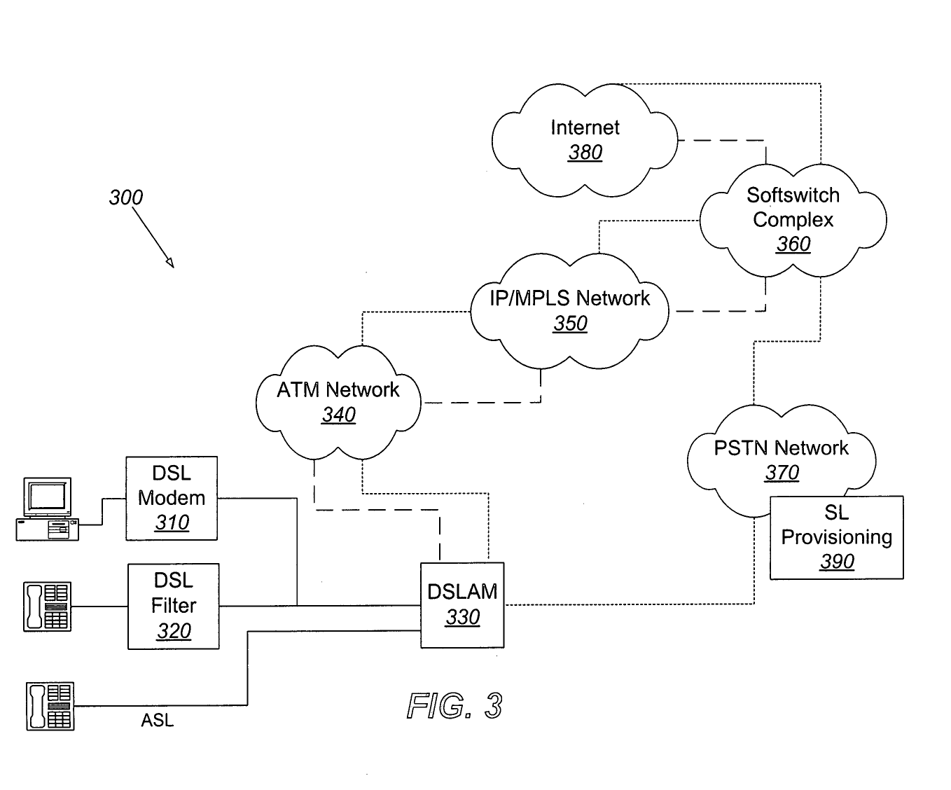

Referring now to FIG. 3, an exemplary communication network 300 in which a DSL line may be provisioned based on a circuit identification, in accordance with some embodiments of the present invention, will now be described. The communication network 300 includes customer premises devices, such as a computer and analog phone, that are connected to a DSL via a DSL modem 310 and DSL filter 320, respectively. The DSL terminates at a Digital Subscriber Line Access Multiplexer (DSLAM) 330 where multiple DSL lines are typically multiplexed and the voice and data components are aggregated for transmission over the network. In some embodiments, the DSLAM 330 may be configured to terminate analog subscriber lines (ASLs), such as POTS lines. As shown in FIG. 3, if a customer subscribes to IP-VoN service, then voice and data components are aggregated for transmission over an ATM network 340, an Internet Protocol/Multiprotocol Label Switching (IP/MPLS) network 350, and a softswitch complex 360. In general, the softswitch complex 360 may provide an interface between circuit switched networks and packet switched networks, such as between the PSTN network 370 and the Internet 380. The softswitch complex 360 may comprise elements, such as a softswitch, media server, and trunk gateway that is used to established connections to the PSTN network 370. Thus, as shown in FIG. 3, voice traffic may be routed to the PSTN network via a trunk gateway while data traffic may be routed to the Internet 380. In some embodiments, voice traffic may also be routed via the Internet.

A customer may also subscribe to CO-VoN in which data traffic is routed from the DSLAM 330 through the ATM network 340, IP/MPLS network 350, softswitch complex 360, and Internet 380 while voice traffic is routed from the DSLAM 330 through the PSTN network 370 to the softswitch complex 360 via a trunk gateway. The ILEC may provide a shadow line number for the DSL along with a hotline service so that originating calls are automatically routed to the softswitch complex 360. The ILEC may also provide a calling name feature for the DSL to provide an identification of a calling party.

The PSTN network may include a SL provisioning function 390 that may include the processing and storage resources for provisioning and managing DSL lines and/or ASL lines, such as POTS lines, in the ILEC network. The SL provisioning function 390 may include the ordering programs that are used to provision service for end customers as well as CLEC customers. This may include, but is not limited to, receiving orders associated with end customers and/or CLECs, porting telephone numbers between the ILEC and the CLECs, and/or provisioning features on the DSL lines and other ILEC facilities.

Although FIG. 3 illustrates an exemplary communication network, it will be understood that the present invention is not limited to such configurations, but is intended to encompass any configuration capable of carrying out the operations described herein.

Computer program code for carrying out operations of the SL provisioning function 390 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

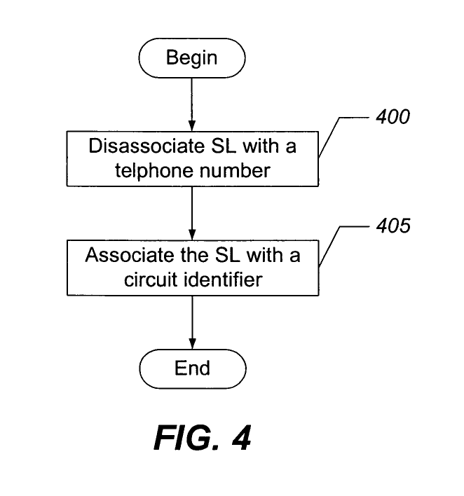

Exemplary operations for provisioning a DSL based on a circuit identification will now be described with reference to FIGS. 4 and 3. Operations begin at block 400 where the SL provisioning function 390 disassociates a SL with a telephone number and then associates the SL with a circuit identifier (block 405). In accordance with various embodiments of the present invention, the SL may be a DSL or an ASL, such as a POTS line. As discussed above, this may allow ILECs, CLECs, and/or other service providers to view telephone numbers as logical and portable objects that are not necessarily tied to a specific physical facility. Moreover, management of the DSL is simplified as customers subscribe to IP-VoN and/or CO-VoN as these services may require porting a telephone number from an ILEC to a CLEC, which may require that the DSL be taken out of service if the DSL is managed based on telephone number. If the DSL is managed based on a circuit identification, however, than there may be no need to disrupt DSL service or the length of time that service is disrupted may be reduced.

The flowchart of FIG. 4 illustrates the architecture, functionality, and operations of some embodiments of methods, systems, and computer program products for provisioning a DSL based on a circuit identification. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

In accordance with various embodiments of the present invention, service interruptions may be reduced in the following exemplary DSL provisioning scenarios:

The telephone number may be ported from an ILEC to a CLEC that provides IP-VoN service. POTS is canceled on the DSL. A one-time service interruption is incurred and the DSL is now identified by the circuit identifier.

IP-VoN service may be converted to CO-VoN service by canceling an association of the telephone number with IP-VoN service. The telephone number is then associated with CO-VoN service. The DSL is provisioned to use a shadow line telephone number with hotline service to route originating calls to a softswitch complex. The DSL is provisioned with calling name to identify a party associated with an incoming call. POTS service is optionally canceled on the DSL. Advantageously, the DSL is identified by the circuit identifier and no DSL service interruption is incurred.

In other embodiments of the present invention, the telephone number is a first telephone number, and Internet Protocol Voice over Network (IP-VoN) service is provisioned using a second telephone number. Plain Old Telephone Service (POTS) is maintained on the DSL using the first telephone number. A one-time service interruption is incurred and the DSL is now identified by the circuit identifier.

CO-VoN service may be established by porting the telephone number from an ILEC to a CLEC that provides CO-VoN service. According to conventional porting methods, the ILEC, as part of porting the telephone number to the CLEC, generates an order for a pseudo telephone number to manage the DSL facility. At the same time, however, the CLEC independently generates a disconnect order for the telephone number. This effectively creates a race condition between the telephone number disconnect order initiated by the CLEC and the order for the pseudo telephone number issued by the ILEC. Because these orders are independent of each other, they cannot be sequenced so that the pseudo telephone number order request is fulfilled soon after the telephone number disconnect order is completed. As a result, the DSL facility may be re-assigned before the pseudo telephone number order request is fulfilled, which may cause a significant delay before a new DSL facility may be provisioned and the pseudo telephone number assigned thereto. Advantageously, some embodiments of the present invention may allow the DSL facility to remain intact during the process of porting the telephone number from an ILEC to a CLEC that provides CO-VoN service.

In particular, POTS is canceled on the DSL. The DSL is provisioned to use a shadow line telephone number with hotline service to route originating calls to a softswitch complex. The DSL is also provisioned with calling name to identify a party associated with an incoming call. The CLEC may also provide IP-VoN service. A one-time service interruption is incurred and the DSL is now identified by the circuit identifier.

CO-VoN service may be converted to IP-VoN service by canceling an association of the telephone number with CO-VoN service. The telephone number is then associated with IP-VoN service. The shadow line number, hotline service, and calling name feature are canceled. Advantageously, the DSL is identified by the circuit identifier and no DSL service interruption is incurred.

In other embodiments of the present invention, the telephone number is ported from a CLEC that provides IP-VoN service to an ILEC. POTS is provisioned on the DSL using the telephone number. Advantageously, the DSL is identified by the circuit identifier and no DSL service interruption is incurred.

In other embodiments of the present invention, the telephone number is ported from a CLEC that provides CO-VoN service to an ILEC. A shadow line number and a hotline service used to route originating calls on the DSL to the softswitch complex are canceled. POTS is provisioned on the DSL using the telephone number. Advantageously, the DSL is identified by the circuit identifier and no DSL service interruption is incurred.

Many variations and modifications can be made to the embodiments described herein without substantially departing from the principles of the present invention. All such variations and modifications are intended to be included herein within the scope of the present invention, as set forth in the following claims.

That which is claimed:

1. A method of provisioning a subscriber line (SL), comprising:
disassociating the SL with a telephone number; and
associating the SL with a circuit identifier in a communications network.

2. The method of claim 1, wherein the SL is an analog subscriber line (ASL).

3. The method of claim 1, wherein the SL is a digital subscriber line (DSL).

4. The method of claim 3, further comprising:
porting the telephone number from an Incumbent Local Exchange Carrier (ILEC) to a Competitive Local Exchange Carrier (CLEC) that provides Internet Protocol Voice over Network (IP-VoN) service; and
canceling Plain Old Telephone Service (POTS) on the DSL.

5. The method of claim 4, further comprising:
canceling Plain Old Telephone Service (POTS) on the DSL;
canceling an association of the telephone number with IP-VoN service;
associating the telephone number with Central Office Voice over Network (CO-VoN) service;
provisioning the DSL to use a shadow line telephone number with hotline service to route originating calls to a softswitch complex; and
provisioning the DSL with calling name to identify a party associated with an incoming call.

6. The method of claim 3, wherein the telephone number is a first telephone number, the method further comprising:
provisioning Internet Protocol Voice over Network (IP-VoN) service using a second telephone number; and
maintaining Plain Old Telephone Service (POTS) on the DSL using the first telephone number.

7. The method of claim 3, further comprising:
porting the telephone number from an Incumbent Local Exchange Carrier (ILEC) to a Competitive Local Exchange Carrier (CLEC) that provides Central Office Voice over Network (CO-VoN) service while leaving the DSL intact.

8. The method of claim 7, further comprising:
canceling Plain Old Telephone Service (POTS) on the DSL;
provisioning the DSL to use a shadow line telephone number with hotline service to route originating calls to a softswitch complex; and
provisioning the DSL with calling name to identify a party associated with an incoming call.

9. The method of claim 8, further comprising:
canceling an association of the telephone number with CO-VoN service;
associating the telephone number with Internet Protocol Voice over Network (IP-VoN) service; and
canceling the shadow line number, hotline service, and calling name.

10. The method of claim 8, wherein the CLEC also provides Internet Protocol Voice over Network (IP-VoN) service.

11. The method of claim 3, further comprising:
porting the telephone number from a Competitive Local Exchange Carrier (CLEC) that provides Internet Protocol Voice over Network (IP-VoN) service to an Incumbent Local Exchange Carrier (ILEC); and
provisioning Plain Old Telephone Service (POTS) on the DSL using the telephone number.

12. The method of claim 3, further comprising:
porting the telephone number from a Competitive Local Exchange Carrier (CLEC) that provides Central Office Voice over Network (CO-VoN) service to an Incumbent Local Exchange Carrier (ILEC);
canceling a shadow line number and a hotline service used to route originating calls on the DSL to a softswitch complex; and
provisioning Plain Old Telephone Service (POTS) on the DSL using the telephone number.

13. A system for provisioning a subscriber line (SL), comprising:
means for disassociating the SL with a telephone number; and
means for associating the SL with a circuit identifier in a communications network.

14. The system of claim 13, wherein the SL is a digital subscriber line (DSL), the system further comprising:
means for porting the telephone number from an Incumbent Local Exchange Carrier (ILEC) to a Competitive Local Exchange Carrier (CLEC) that provides Central Office Voice over Network (CO-VoN) service;
means for canceling Plain Old Telephone Service (POTS) on the DSL;
means for provisioning the DSL to use a shadow line telephone number with hotline service to route originating calls to a softswitch complex; and
means for provisioning the DSL with calling name to identify a party associated with an incoming call.

15. The system of claim 13, wherein the SL is a digital subscriber line (DSL), the system further comprising:
means for porting the telephone number from a Competitive Local Exchange Carrier (CLEC) that provides Internet Protocol Voice over Network (IP-VoN) service to an Incumbent Local Exchange Carrier (ILEC); and
means for provisioning Plain Old Telephone Service (POTS) on the DSL using the telephone number.

16. The system of claim 13, wherein the SL is a digital subscriber line (DSL), the system further comprising:
means for porting the telephone number from a Competitive Local Exchange Carrier (CLEC) that provides Central Office Voice over Network (CO-VoN) service to an Incumbent Local Exchange Carrier (ILEC);
means for canceling a shadow line number and a hotline service used to route originating calls on the DSL to a softswitch complex; and
means for provisioning Plain Old Telephone Service (POTS) on the DSL using the telephone number.

17. A computer program product for provisioning a subscriber line (SL), comprising:
a computer readable storage medium having computer readable program code embodied therein, the computer readable program code comprising:
computer readable program code configured to disassociate the SL with a telephone number; and
computer readable program code configured to associate the SL with a circuit identifier in a communications network.

18. The computer program product of claim 17, wherein the SL is a digital subscriber line (DSL), the computer program product further comprising:
computer readable program code configured to port the telephone number from an Incumbent Local Exchange Carrier (ILEC) to a Competitive Local Exchange Carrier (CLEC) that provides Central Office Voice over Network (CO-VoN) service;
computer readable program code configured to cancel Plain Old Telephone Service (POTS) on the DSL;
computer readable program code configured to provision the DSL to use a shadow line telephone number with hotline service to route originating calls to a softswitch complex; and
computer readable program code configured to provision the DSL with calling name to identify a party associated with an incoming call.

19. The computer program product of claim 17, wherein the SL is a digital subscriber line (DSL), the computer program product further comprising:
computer readable program code configured to port the telephone number from a Competitive Local Exchange Carrier (CLEC) that provides Internet Protocol Voice over Network (IP-VoN) service to an Incumbent Local Exchange Carrier (ILEC); and
computer readable program code configured to provision Plain Old Telephone Service (POTS) on the DSL using the telephone number.

20. The computer program product of claim 17, wherein the SL is a digital subscriber line (DSL), the computer program product further comprising:
computer readable program code configured to port the telephone number from a Competitive Local Exchange Carrier (CLEC) that provides Central Office Voice over Network (CO-VoN) service to an Incumbent Local Exchange Carrier (ILEC);
computer readable program code configured to cancel a shadow line number and a hotline service used to route originating calls on the DSL to a softswitch complex; and
computer readable program code configured to provision Plain Old Telephone Service (POTS) on the DSL using the telephone number.
